(19) United States
(12) Patent Application Publication
(10) Pub. No.: US 2013/0107860 A1
(43) Pub. Date: May 2, 2013

(54) REDUCING SERVICE INTERRUPTION OF VOICE OVER INTERNET PROTOCOL (VoIP) CALLS DUE TO INTER-RADIO ACCESS TECHNOLOGY (RAT) HANDOVER

(71) Applicants: Guangming Shi, San Diego, CA (US); Tom Chin, San Diego, CA (US); Kuo-Chun Lee, San Diego, CA (US)

(72) Inventors: Guangming Shi, San Diego, CA (US); Tom Chin, San Diego, CA (US); Kuo-Chun Lee, San Diego, CA (US)

(73) Assignee: QUALCOMM Incorporated, San Diego, CA (US)

(21) Appl. No.: 13/283,531

(22) Filed: Oct. 27, 2011

(51) Int. Cl. H04W 36/00; H04B 7/216; H04B 7/208; H04L 12/66

(52) U.S. Cl. 370/331

(57) ABSTRACT

Aspects of the present disclosure provide methods for a multi-mode MS to perform a sequence of operations to handover from a CDMA EVDO network to a WiMAX network while intermittently switching to the CDMA EVDO network, between operations of a handover sequence, to exchange data. According to aspects, the MS may transmit a data rate control (DRC) cover indicating a null cover value or a valid sector cover value to avoid user detection of service disruption while performing handover signaling procedures in the WiMAX network.

### BACKGROUND

1. Field

Certain aspects of the present disclosure generally relate to wireless communication and, more particularly, performing a sequence of operations to handover from a first radio access technology (RAT) to a second RAT.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency divisional multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is LTE. LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

Orthogonal frequency-division multiplexing (OFDM) and orthogonal frequency division multiple access (OFDMA) wireless communication systems under IEEE 802.16 use a network of base stations to communicate with wireless devices (i.e., mobile stations) registered for services in the systems based on the orthogonality of frequencies of multiple subcarriers and can be implemented to achieve a number of technical advantages for wideband wireless communications, such as resistance to multipath fading and interference. Each base station (BS) emits and receives radio frequency (RF) signals that convey data to and from the mobile stations. For various reasons, such as a mobile station (MS) moving away from the area covered by one base station and entering the area covered by another, a handover (also known as a handoff) may be performed to transfer communication services (e.g., an ongoing call or data session) from one base station to another.

In some cases, a mobile station (MS) may support multiple radio access technologies (RATs). Such a “multi-mode” MS may be required to perform “inter-RAT” handovers, between different RATs.

The capability to perform inter-RAT handovers may provide a broader coverage area for an MS. Unfortunately, data continuity is typically lost when performing an inter-RAT handover. In other words, a data connection maintained in a first RAT prior to the handover is typically lost during the handover and a new connection must be established in the second RAT. This loss of data continuity may result in service interruption and a less than ideal user experience.

### SUMMARY

In an aspect of the disclosure, a method for wireless communication is provided. The method generally includes performing a sequence of operations to handover from a first radio access technology (RAT) to a second RAT, and intermittently switching from the second RAT to the first RAT between operations of the sequence to exchange data in the first RAT.

In an aspect of the disclosure, an apparatus for wireless communication is provided. The apparatus generally includes means for performing a sequence of operations to handover from a first radio access technology (RAT) to a second RAT, and means for intermittently switching from the second RAT to the first RAT between operations of the sequence to exchange data in the first RAT.

In an aspect of the disclosure, an apparatus for wireless communication is provided. The apparatus generally includes at least one processor and a memory coupled to the at least one processor. The at least one processor is generally configured to perform a sequence of operations to handover from a first radio access technology (RAT) to a second RAT, and intermittently switch from the second RAT to the first RAT between operations of the sequence to exchange data in the first RAT.

In an aspect of the disclosure, a computer-program product for wireless communication is provided. The computer-program product generally includes a non-transitory computer-readable medium having code stored thereon. The code is generally executable by one or more processors for performing a sequence of operations to handover from a first radio access technology (RAT) to a second RAT, and intermittently switching from the second RAT to the first RAT between operations of the sequence to exchange data in the first RAT.

### BRIEF DESCRIPTION OF THE DRAWINGS

So that the manner in which the above recited features of the present disclosure can be understood in detail, a more particular description, briefly summarized above, may be had by reference to embodiments, some of which are illustrated in the appended drawings. It is to be noted, however, that the appended drawings illustrate only certain typical embodiments of this disclosure and are therefore not to be considered limiting of its scope, for the description may admit to other equally effective embodiments.

FIG. 1 illustrates an example wireless communication system, in accordance with certain aspects of the present disclosure.

FIG. 2 illustrates various components that may be utilized in a wireless device, in accordance with certain aspects of the present disclosure.

FIG. 3 illustrates an example transmitter and an example receiver that may be used within a wireless communication system that utilizes orthogonal frequency-division multiplexing and orthogonal frequency division multiple access (OFDM/OFDMA) technology, in accordance with certain aspects of the present disclosure.

FIG. 4 illustrates example operations which may be performed, for example, by a mobile station, in accordance with certain aspects of the present disclosure.

FIG. 5 illustrates an example sequence of operations for inter-RAT handover, in accordance with certain aspects of the present disclosure.

### DETAILED DESCRIPTION

Certain aspects of the present disclosure provide methods performing a sequence of operations to handover from a first RAT to a second RAT while intermittently exchanging data in the first RAT between handover operations in the second RAT.

An Example Wireless Communication System

The methods and apparatus of the present disclosure may be utilized in a broadband wireless communication system. The term “broadband wireless” refers to technology that provides wireless, voice, Internet, and/or data network access over a given area.

WiMAX, which stands for the Worldwide Interoperability for Microwave Access, is a standards-based broadband wireless technology that provides high-throughput broadband connections over long distances. There are two main applications of WiMAX today: fixed WiMAX and mobile WiMAX. Fixed WiMAX applications are point-to-multipoint, enabling broadband access to homes and businesses, for example. Mobile WiMAX offers the full mobility of cellular networks at broadband speeds.

Mobile WiMAX is based on OFDM (orthogonal frequency-division multiplexing) and OFDMA (orthogonal frequency division multiple access) technology. OFDM is a digital multi-carrier modulation technique that has recently found wide adoption in a variety of high-data-rate communication systems. With OFDM, a transmit bit stream is divided into multiple lower-rate substreams. Each substream is modulated with one of multiple orthogonal subcarriers and sent over one of a plurality of parallel subchannels. OFDMA is a multiple access technique in which users are assigned subcarriers in different time slots. OFDMA is a flexible multiple-access technique that can accommodate many users with widely varying applications, data rates, and quality of service requirements.

The rapid growth in wireless internets and communications has led to an increasing demand for high data rate in the field of wireless communications services. OFDM/OFDMA systems are today regarded as one of the most promising research areas and as a key technology for the next generation of wireless communications. This is due to the fact that OFDM/OFDMA modulation schemes can provide many advantages such as modulation efficiency, spectrum efficiency, flexibility, and strong multipath immunity over conventional single carrier modulation schemes.

IEEE 802.16x is an emerging standard organization to define an air interface for fixed and mobile broadband wireless access (BWA) systems. IEEE 802.16x approved “IEEE P802.16-REVd/D5-2004” in May 2004 for fixed BWA systems and published “IEEE P802.16e/D12 Oct. 2005” in October 2005 for mobile BWA systems. Those two standards defined four different physical layers (PHYs) and one media access control (MAC) layer. The OFDM and OFDMA physical layer of the four physical layers are the most popular in the fixed and mobile BWA areas respectively.

As those skilled in the art will readily appreciate from the detailed description to follow, the various concepts presented herein are well suited for WiMAM applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), LTE, IEEE 802.20, and Flash-OFDM employing OFDMA. UTRA, E-URA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

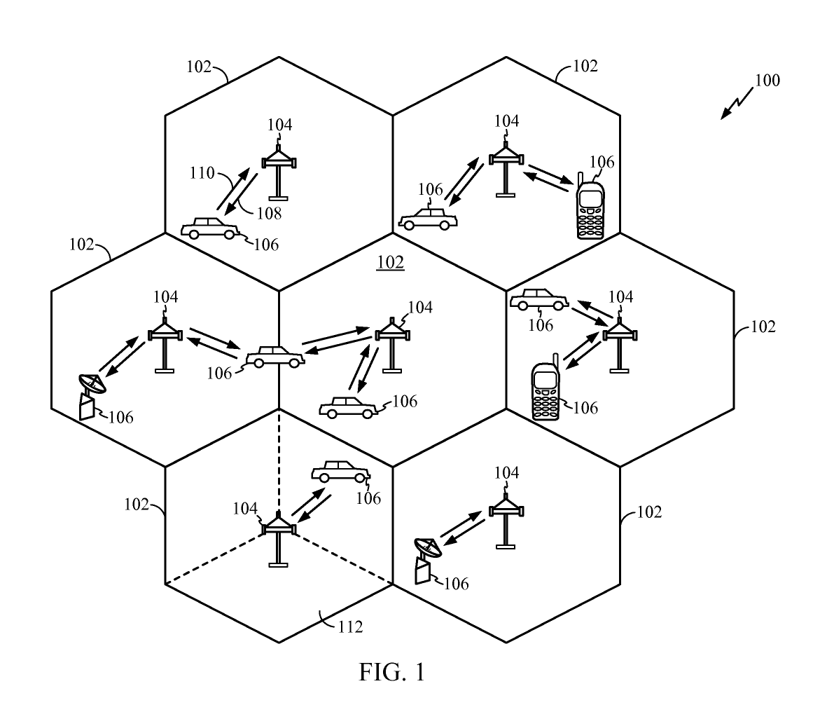

FIG. 1 illustrates an example of a wireless communication system 100. The wireless communication system 100 may be a broadband wireless communication system. The wireless communication system 100 may provide communication for a number of cells 102, each of which is serviced by a base station 104. A base station 104 may be a fixed station that communicates with user terminals 106. The base station 104 may alternatively be referred to as an access point, a Node B, or some other terminology.

FIG. 1 depicts various user terminals 106 dispersed throughout the system 100. The user terminals 106 may be fixed (i.e., stationary) or mobile. The user terminals 106 may alternatively be referred to as remote stations, access terminals, terminals, subscriber units, mobile stations, stations, user equipment, etc. The user terminals 106 may be wireless devices, such as cellular phones, personal digital assistants (PDAs), handheld devices, wireless modems, laptop computers, personal computers (PCs), etc.

A variety of algorithms and methods may be used for transmissions in the wireless communication system 100 between the base stations 104 and the user terminals 106. For example, signals may be sent and received between the base stations 104 and the user terminals 106 in accordance with OFDM/OFDMA techniques. If this is the case, the wireless communication system 100 may be referred to as an OFDM/OFDMA system.

A communication link that facilitates transmission from a base station 104 to a user terminal 106 may be referred to as a downlink 108, and a communication link that facilitates transmission from a user terminal 106 to a base station 104 may be referred to as an uplink 110. Alternatively, a downlink 108 may be referred to as a forward link or a forward channel, and an uplink 110 may be referred to as a reverse link or a reverse channel.

A cell 102 may be divided into multiple sectors 112. A sector 112 is a physical coverage area within a cell 102. Base stations 104 within a wireless communication system 100 may utilize antennas that concentrate the flow of power within a particular sector 112 of the cell 102. Such antennas may be referred to as directional antennas.

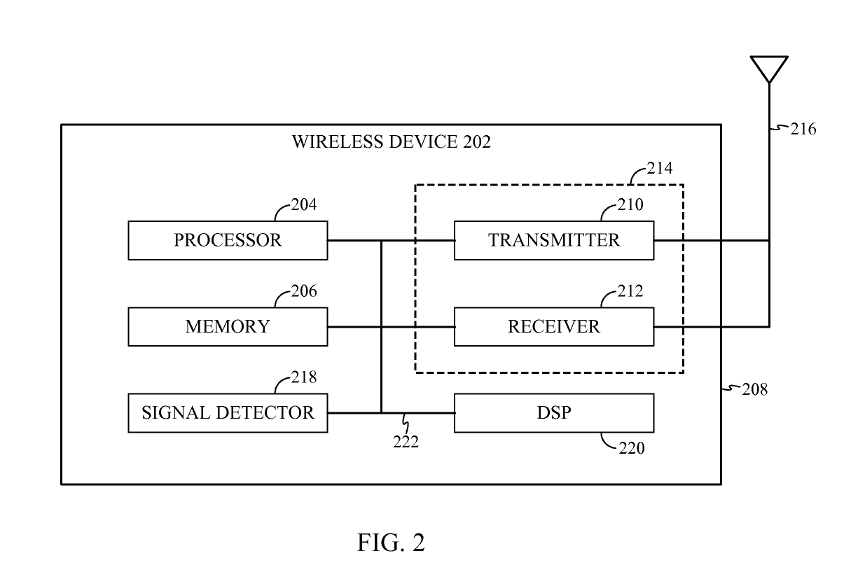

FIG. 2 illustrates various components that may be utilized in a wireless device 202. The wireless device 202 is an example of a device that may be configured to implement the various methods described herein. The wireless device 202 may be a base station 104 or a user terminal 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

The wireless device 202 may also include a housing 208 that may include a transmitter 210 and a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas.

The wireless device 202 may also include a signal detector 218 that may be used in an effort to detect and quantify the level of signals received by the transceiver 214. The signal detector 218 may detect such signals as total energy, pilot energy from pilot subcarriers or signal energy from the preamble symbol, power spectral density, and other signals. The wireless device 202 may also include a digital signal processor (DSP) 220 for use in processing signals.

The various components of the wireless device 202 may be coupled together by a bus system 222, which may include a power bus, a control signal bus, and a status signal bus in addition to a data bus.

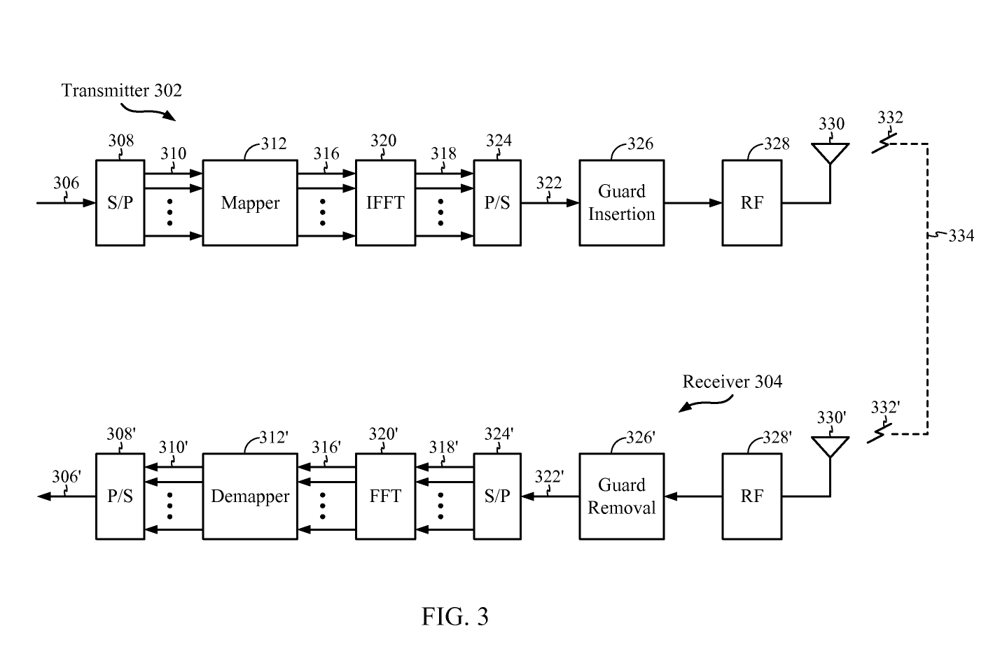

FIG. 3 illustrates an example of a transmitter 302 that may be used within a wireless communication system 100 that utilizes OFDM/OFDMA. Portions of the transmitter 302 may be implemented in the transmitter 210 of a wireless device 202. The transmitter 302 may be implemented in a base station 104 for transmitting data 306 to a user terminal 106 on a downlink 108. The transmitter 302 may also be implemented in a user terminal 106 for transmitting data 306 to a base station 104 on an uplink 110.

Data 306 to be transmitted is shown being provided as input to a serial-to-parallel (S/P) converter 308. The S/P converter 308 may split the transmission data into N parallel data streams 310.

The N parallel data streams 310 may then be provided as input to a mapper 312. The mapper 312 may map the N parallel data streams 310 onto N constellation points. The mapping may be done using some modulation constellation, such as binary phase-shift keying (BPSK), quadrature phase-shift keying (QPSK), 8 phase-shift keying (8PSK), quadrature amplitude modulation (QAM), etc. Thus, the mapper 312 may output N parallel symbol streams 316, each symbol stream 316 corresponding to one of the N orthogonal subcarriers of the inverse fast Fourier transform (IFFT) 320. These N parallel symbol streams 316 are represented in the frequency domain and may be converted into N parallel time domain sample streams 318 by an IFFT component 320.

A brief note about terminology will now be provided. N parallel modulations in the frequency domain are equal to N modulation symbols in the frequency domain, which are equal to N mapping and N-point IFFT in the frequency domain, which is equal to one (useful) OFDM symbol in the time domain, which is equal to N samples in the time domain. One OFDM symbol in the time domain, Nₛ, is equal to N_{cp} (the number of guard samples per OFDM symbol)+N (the number of useful samples per OFDM symbol).

The N parallel time domain sample streams 318 may be converted into an OFDM/OFDMA symbol stream 322 by a parallel-to-serial (P/S) converter 324. A guard insertion component 326 may insert a guard interval between successive OFDM/OFDMA symbols in the OFDM/OFDMA symbol stream 322. The output of the guard insertion component 326 may then be upconverted to a desired transmit frequency band by a radio frequency (RF) front end 328. An antenna 330 may then transmit the resulting signal 332.

FIG. 3 also illustrates an example of a receiver 304 that may be used within a wireless communication system 100 that utilizes OFDM/OFDMA. Portions of the receiver 304 may be implemented in the receiver 212 of a wireless device 202. The receiver 304 may be implemented in a user terminal 106 for receiving data 306 from a base station 104 on a downlink 108. The receiver 304 may also be implemented in a base station 104 for receiving data 306 from a user terminal 106 on an uplink 110.

The transmitted signal 332 is shown traveling over a wireless channel 334. When a signal 332′ is received by an antenna 330′, the received signal 332′ may be downconverted to a baseband signal by an RF front end 328′. A guard removal component 326′ may then remove the guard interval that was inserted between OFDM/OFDMA symbols by the guard insertion component 326.

The output of the guard removal component 326′ may be provided to an S/P converter 324′. The S/P converter 324′ may divide the OFDM/OFDMA symbol stream 322′ into the N parallel time-domain symbol streams 318′, each of which corresponds to one of the N orthogonal subcarriers. A fast Fourier transform (FFT) component 320′ may convert the N parallel time-domain symbol streams 318′ into the frequency domain and output N parallel frequency-domain symbol streams 316′.

A demapper 312′ may perform the inverse of the symbol mapping operation that was performed by the mapper 312, thereby outputting N parallel data streams 310′. A P/S converter 308′ may combine the N parallel data streams 310′ into a single data stream 306′. Ideally, this data stream 306′ corresponds to the data 306 that was provided as input to the transmitter 302.

Reducing Service Interruption of VoIP Calls During Handover from EVDO to WiMax

Aspects of the present disclosure provide techniques that may help reduce service interruptions when performing an inter-RAT handover. The techniques may be performed, for example, by a multi-mode mobile station (MS) capable of communicating with a plurality of different RAT networks.

One example of such a multi-mode MS may establish a Voice over Internet Protocol (VoIP) call in a Code Division Multiple Access (CDMA) Evolution-Data Optimized (EVDO) network and may need to handover to a Worldwide Interoperability for Microwave Access (WiMAX) network while the call is running

Aspects of the present disclosure allow such a multi-mode MS to perform a sequence of operations to handover from the CDMA EVDO network to the WiMAX network while intermittently exchanging data in the CDMA EVDO network between operations of the handover sequence.

A MS may need to complete several time-consuming procedures to perform a handover to a WiMAX network. For example, to establish a radio link in the WiMAX network, the MS may need to complete ranging procedures, Subscriber Basic Capability (SBC) negotiations, authentication operations, registration operations, Dynamic Service Flow Addition (DSA), service flow activation, and IP protocol initialization (e.g., Dynamic Host Configuration Protocol (DHCP), Mobile Internet Protocol (MIP)).

While establishing a radio link in the WiMAX network may be time-consuming, only a few seconds may be needed to complete WiMAX network entry procedures. During WiMAX network entry procedures, VoIP data services may be disrupted, for example, because VoIP data transmissions may be on hold. Accordingly, aspects of the present disclosure provide methods to reduce the service disruption time during an inter-RAT handover from CDMA EVDO to WiMAX.

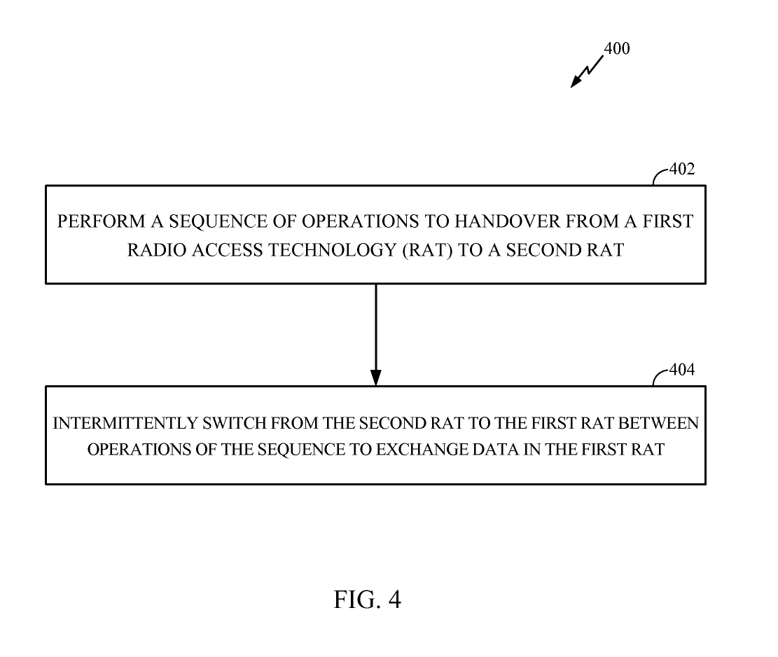

FIG. 4 illustrates example operations 400 which may be performed to reduce service interruption during an inter-RAT handover. For example, the operations 400 may be performed by a multi-mode MS capable of communicating in any number of different RAT networks.

At 402, a MS may perform a sequence of operations to handover from a first RAT to a second RAT. At 404, the MS may intermittently switch from the second RAT to the first RAT between operations of the sequence to exchange data in the first RAT.

The intermittent switching back to the first RAT may allow data continuity to be maintained and avoid or reduce service interruption caused by the handover. Exactly how the MS achieves this may depend on a particular implementation.

For example, according to aspects, a MS may activate the MAC/L3 protocol stacks of the two RATs using a single transmit and receive chain. As will be described in more detail below, the MS may continue to send and receive VoIP data while performing handover signaling procedures using a data rate control (DRC) cover indicating a null cover value and a DRC cover indicating a valid sector cover value.

For example, the MS may transmit a DRC cover indicating a null cover value prior to switching from a CDMA EVDO network to a WiMAX network. The MS may transmit a DRC cover indicating a valid sector cover value prior to exchanging data in the CDMA EVDO network. According to aspects, the MS may use the WiMAX sleep mode to continue to transmit and receive data in the CDMA EVDO network while performing handover signaling procedures with the WiMAX network.

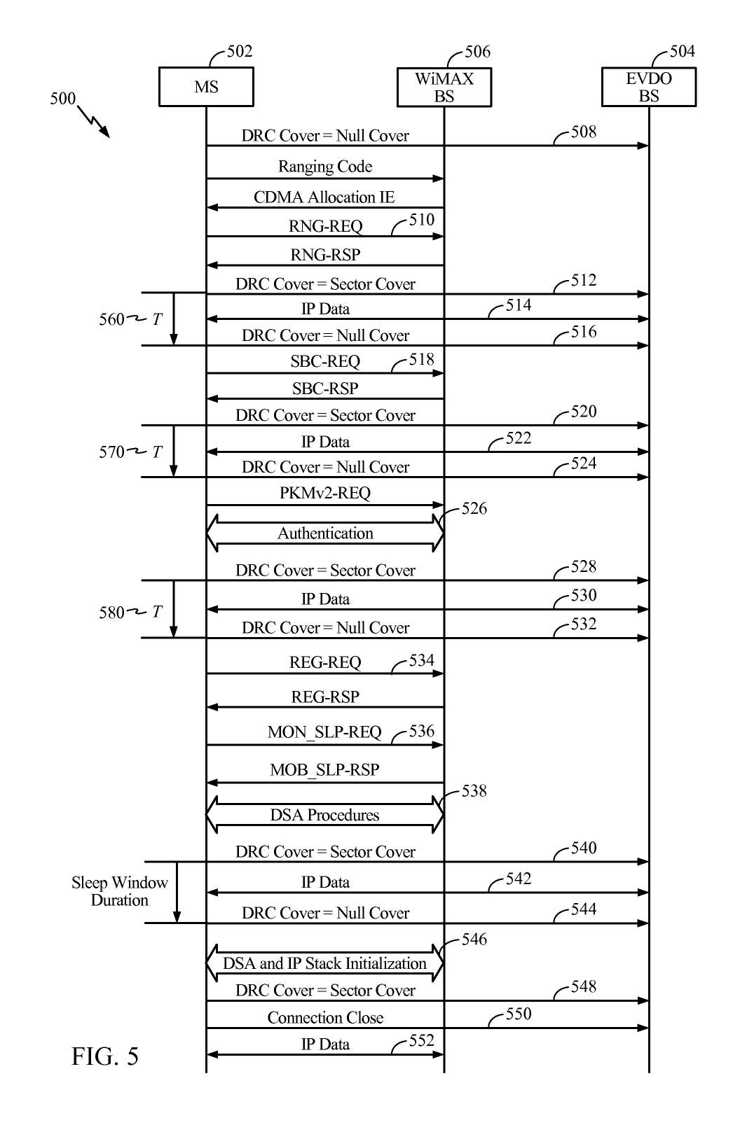

FIG. 5 illustrates an example sequence of operations 500 for inter-RAT handover, according to aspects of the present disclosure. Initially, a MS 502 may establish a VoIP call with a base station in a CDMA EVDO network (EVDO BS) 504 and may need to handover to a base station in a WiMAX network (WiMAX BS) 506.

Inter-RAT handover operations may begin, at 508, when the MS 502 transmits a DRC cover indicating a null cover value to the EVDO BS 504 and switches to the WiMAX network. At 510, the MS 502 performs ranging procedures in an effort to establish a radio link in the WiMAX network.

Upon completion of ranging procedures, the MS 502 may switch back to the EVDO network and may resume DRC reporting. For example, at 512, the MS 502 may transmit a DRC cover indicating a valid sector cover value. At 514, the MS 502 may resume transmitting and receiving IP data with the EVDO BS 504.

At 516, some time period T 560 after the MS 502 transmits the DRC cover indicating a valid sector cover value 512, the MS 502 may transmit a DRC cover indicating a null cover value to the EVDO BS 504 and may switch to the WiMAX network.

At 518, while in the WiMAX network, the MS 502 may continue procedures to establish a WiMAX radio link by performing SBC procedures. Upon completion of SBC procedures, at 520, the MS 502 may transmit a DRC cover indicating a valid sector cover value to the EVDO BS 504 and may switch back to the EVDO network. At 522, the MS 502 may resume transmitting and receiving IP data with the EVDO BS 504.

Some time period T 570 after the MS 502 transmits the DRC cover indicating a valid sector cover value 520, the MS 502 may continue procedures to establish a radio link in the WiMAX network. For example, at 524, the MS 502 may transmit a DRC cover indicating a null cover value to the EVDO BS 504 and may switch back to the WiMAX network. At 526, the MS 502 may perform authentication procedures with the WiMAX BS 506.

After completion of authentication procedures in the WiMAX network, at 528, the MS 502 may transmit a DRC cover indicating a valid sector cover value to the EVDO BS 504 and may switch back to the EVDO network. At 530, the MS 502 may resume transmitting and receiving IP data with the EVDO BS 504.

Some time period T 580 after the MS 502 transmits the DRC cover indicating a valid sector cover value 528, the MS 502 may switch back to the WiMAX network in an effort to continue procedures to establish a WiMAX radio link. For example, at 532, the MS 502 may transmit a DRC cover indicating a null cover value to the EVDO BS 504. At 534, the MS 502 may continue to establish a radio link in the WiMAX network by performing registration procedures.

Upon completion of registration procedures, at 536, the MS 502 may request to activate a sleep mode in the WiMAX network. According to aspects, the MS 502 may request to activate Power Saving Class (PSC) Type2 sleep mode. As will be described in more detail below, the PSC Type 2 sleep window and the timer to stay in the EVDO network may be set to avoid frequent switching between the EVDO and WiMAX networks and to avoid user detection of service disruption during handover operations. For example, a duration of time for transmitting and receiving data between the MS 502 and EVDO BS 504 may be set to occur within the WiMAX sleep window.

According to aspects, the MS 502 may remain in the WiMAX network until the beginning of the sleep window. At 538, the MS 502 may continue to procedures to establish a radio link in the WiMAX network by performing DSA procedures.

At the beginning of the WiMAX sleep window, the MS 502 may switch to the EVDO network by transmitting, at 540, a DRC cover indicating a valid sector cover value to the EVDO BS 504. At 542, the MS may resume transmitting and receiving IP data with the EVDO BS 504. While in the EVDO network, the MS 502 may continue to transmit and receive VoIP packets until a timer to stay in the EVDO network expires. According to aspects, the timer to stay in the EVDO network may expire before the end of the WiMAX sleep window in an effort to minimize user detection of service disruption.

At 544, the MS 502 may transmit a DRC cover indicating a null cover value to the EVDO BS 504 and may switch back to the WiMAX network to continue handover procedures. The MS may switch to the WiMAX network before the end of a WiMAX unavailable interval, for example, before the end of the WiMAX sleep window.

While in the WiMAX network, MS 502 may perform procedures, at 546, to establish one or more transport connections and IP stack initialization (e.g., Dynamic Host Configuration Protocol (DHCP)). Upon completing IP stack initialization in the WiMAX network, the MS 502 may switch back to the EVDO network by transmitting, at 548, a DRC cover indicating a valid sector cover value to the EVDO BS 504.

The MS 502 may enter an idle state in the EVDO network by transmitting, at 550, a connection close message to the EVDO BS 504. At 552, handover from the EVDO BS 504 to the WiMAX BS 506 is complete. The MS 502 may terminate switching between the EVDO BD 504 and WiMAX BS 506 and may begin transmitting and receiving IP data in the WiMAX network.

As presented in the examples above, an MS may perform the techniques presented herein when handing over from a BS in a CDMA EVDO network to a BS in a WiMAX network. According to aspects, the MS may perform a sequence of handover operations in the WiMAX network while intermittently switching to the CDMA EVDO network to exchange data.

The MS may use a DRC cover indicating a null cover value to switch to the WiMAX network and a DRC cover indicating a valid sector cover value prior to exchanging data in the CDMA EVDO network. According to aspects, a MS may transmit and receive data with the CDMA EVDO network during a WiMAX sleep interval in an effort to avoid service disruption and user detection during handover signaling procedures.

While techniques have been described with reference to particular examples involving WiMAX and CDMA networks, those skilled in the art will recognize that the techniques presented herein may be more generally applied to reduce service disruption when a multi-mode MS performs an inter-RAT handover between any different types of RAT networks.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The various operations of methods described above may be performed by various hardware and/or software component(s) and/or module(s) corresponding to means-plus-function blocks illustrated in the Figures. More generally, where there are methods illustrated in Figures having corresponding counterpart means-plus-function Figures, the operation blocks correspond to means-plus-function blocks with similar numbering.

Information and signals may be represented using any of a variety of different technologies and techniques. For example, data, instructions, commands, information, signals and the like that may be referenced throughout the above description may be represented by voltages, currents, electromagnetic waves, magnetic fields or particles, optical fields or particles or any combination thereof.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. . Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of indicates a disjunctive list such that, for example, a list of “at least one of A, B, or C” means A or B or C or AB or AC or BC or ABC (i.e., A and B and C).

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. A method for wireless communication, comprising:
performing a sequence of operations to handover from a first radio access technology (RAT) to a second RAT; and
intermittently switching from the second RAT to the first RAT between operations of the sequence to exchange data in the first RAT.

2. The method of claim 1, wherein the data comprises voice over internet protocol (VoIP) packets.

3. The method of claim 1, wherein:
the first RAT comprises a Code Division Multiple Access (CDMA) RAT; and
the second RAT comprises at least one of orthogonal frequency-division multiplexing (OFDM) or orthogonal frequency division multiple access (OFDMA) RAT.

4. The method of claim 3, wherein intermittently switching from the second RAT to the first RAT comprises:
transmitting a data rate control (DRC) cover indicating a null cover value prior to switching from the first RAT to the second RAT; and
transmitting a DRC cover indicating a valid sector cover value prior to exchanging data in the first RAT.

5. The method of claim 1, wherein the sequence of operations comprises at least one of:
ranging operations;
authentication operations;
registration operations;
service flow activation; and
internet protocol (IP) initialization operations.

6. The method of claim 1, further comprising:
terminating switching from the second RAT to the first RAT after the handover is complete.

7. An apparatus for wireless communication, comprising:
means for performing a sequence of operations to handover from a first radio access technology (RAT) to a second RAT; and
means for intermittently switching from the second RAT to the first RAT between operations of the sequence to exchange data in the first RAT.

8. The apparatus of claim 7, wherein the data comprises voice over internet protocol (VoIP) packets.

9. The apparatus of claim 7, wherein:
the first RAT comprises a Code Division Multiple Access (CDMA) RAT; and
the second RAT comprises at least one of orthogonal frequency-division multiplexing (OFDM) or orthogonal frequency division multiple access (OFDMA) RAT.

10. The apparatus of claim 9, wherein the means for intermittently switching from the second RAT to the first RAT comprises:
means for transmitting a data rate control (DRC) cover indicating a null cover value prior to switching from the first RAT to the second RAT; and
means for transmitting a DRC cover indicating a valid sector cover value prior to exchanging data in the first RAT.

11. The apparatus of claim 7, wherein the sequence of operations comprises at least one of:
ranging operations;
authentication operations;
registration operations;
service flow activation; and
internet protocol (IP) initialization operations.

12. The apparatus of claim 7, further comprising:
means for terminating switching from the second RAT to the first RAT after the handover is complete.

13. An apparatus for wireless communication, comprising:
at least one processor configured to:
perform a sequence of operations to handover from a first radio access technology (RAT) to a second RAT; and
intermittently switch from the second RAT to the first RAT between operations of the sequence to exchange data in the first RAT; and
a memory coupled to the at least one processor.

14. The apparatus of claim 13, wherein the data comprises voice over internet protocol (VoIP) packets.

15. The apparatus of claim 13, wherein:
the first RAT comprises a Code Division Multiple Access (CDMA) RAT; and
the second RAT comprises at least one of orthogonal frequency-division multiplexing (OFDM) or orthogonal frequency division multiple access (OFDMA) RAT.

16. The apparatus of claim 15, wherein the at least one processor is configured to intermittently switch from the second RAT to the first RAT by:
transmitting a data rate control (DRC) cover indicating a null cover value prior to switching from the first RAT to the second RAT; and
transmitting a DRC cover indicating a valid sector cover value prior to exchanging data in the first RAT.

17. The apparatus of claim 13, wherein the sequence of operations comprises at least one of:
ranging operations;
authentication operations;
registration operations;
service flow activation; and
internet protocol (IP) initialization operations.

18. The apparatus of claim 13, wherein the at least one processor is further configured to:
terminate switching from the second RAT to the first RAT after the handover is complete.

19. A computer-program product for wireless communication, the computer-program product comprising a non-transitory computer-readable medium having code stored thereon, the code executable by one or more processors for:
performing a sequence of operations to handover from a first radio access technology (RAT) to a second RAT; and
intermittently switching from the second RAT to the first RAT between operations of the sequence to exchange data in the first RAT.

20. The computer-program product of claim 19, wherein the data comprises voice over internet protocol (VoIP) packets.

21. The computer-program product of claim 19, wherein:
the first RAT comprises a Code Division Multiple Access (CDMA) RAT; and
the second RAT comprises at least one of orthogonal frequency-division multiplexing (OFDM) or orthogonal frequency division multiple access (OFDMA) RAT.

22. The computer-program product of claim 21, wherein the code for intermittently switching from the second RAT to the first RAT comprises:
code for transmitting a data rate control (DRC) cover indicating a null cover value prior to switching from the first RAT to the second RAT; and
code for transmitting a DRC cover indicating a valid sector cover value prior to exchanging data in the first RAT.

23. The computer-program product of claim 19, wherein the sequence of operations comprises at least one of:
ranging operations;
authentication operations;
registration operations;
service flow activation; and
internet protocol (IP) initialization operations.

24. The computer-program product of claim 19, further comprising:
code for terminating switching from the second RAT to the first RAT after the handover is complete.
